(19) United States
(12) Patent Application Publication
(10) Pub. No.: US 2007/0282078 A1
(43) Pub. Date: Dec. 6, 2007

(54) Synthesis of aryl N-acylurea from aryl isocyanates or aryl carbodiimides for use as intermediate in novel sequential self-repetitive reaction (SSRR) to form amides, amide-imides and their polymers

(76) Inventors: Shenghong A. Dai, Taichung City (TW); Jiang-Jen Lin, Taipei (TW); Kuan-Liang Wei, Taichung City (TW); Chih-Heng Wu, Taichung City (TW); Wei-Hsiang Huang, Taichung City (TW)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/444,306

(22) Filed: Jun. 1, 2006

(51) Int. Cl. C08F 283/04

(52) U.S. Cl. 525/424

(57) ABSTRACT

Disclosed is a process for synthesizing an aryl N-acylurea in both high selectivity and high yield, comprising reacting an aryl carbodiimide with a carboxylic acid under mild conditions. Thermolysis of N-acylureas at above about 120° C. gives amides and isocyanates, and the latter will undergo the repetitive reaction sequences in the presence of a carbodiimide catalyst. Based on this unique model, a sequential self-repetitive reaction (SSRR) is also developed in a versatile manner for converting aryl carbodiimides into amides, polyamides, polyamide-imides and polyamide-imide elastomers.

### FIELD OF THE INVENTION

The present invention relates to processes for synthesizing an aryl N-acylurea in both high selectivity and high yield under mild conditions, and to the uses of the obtained aryl N-acylurea as intermediates in a sequential self-repetitive reaction (or a “SSRR” reaction or “SSRR” process for abbreviation) to form amides, amide-imides and their polymers such as polyamides, polyamide-imides, and polyamide-imide elastomers.

### BACKGROUND OF THE INVENTION

Carbodiimides (CDI), easily prepared from isocyanates (see Monagle, J. J.; Campbell, T. W.; Mcshane, H. F. J. Am. Chem. Soc., 1962, 84, 4288), have been known to react with carboxylic acids to form a mixture of acid anhydrides (anhydrides), N,N′-substituted ureas (ureas) and N-acyl-N,N′-disubstituted ureas (N-acylureas). Earlier mechanistic studies by Khorana (see Khorana, H. G. Chem. Rev., 1953, 53, 145, and Smith, M.; Moffatt, J. G.; Khorana, H. G. J. Am. Chem. Soc., 1958, 80, 6204) and Silverstein (see Detar, D. F.; Silverstein, R. J. Am. Chem. Soc., 1966, 88, 1013, and Detar, D. F.; Silverstein, R. J. Am. Chem. Soc., 1966, 88, 1020) showed that two parallel reaction pathways might account for the diversity of products observed. The initial formation of an O-acylisourea intermediate can either rearrange into N-acylurea or undergo a further substitution reaction with another acid molecule to produce the corresponding urea and anhydride as final products.

The earlier literatures indicated that aromatic CDIs seem to favor the formation of N-acylureas upon treatment of carboxylic acids, whereas aliphatic CDIs often lead to the formation of a mixture of anhydrides and N,N′-disubstituted ureas (see Mikolajczyk, M.; Kielbasinski, P. Tetrahedron, 1980, 37, 233, and Volonterio, A.; Arellano, C. R.; Zanda, M. J. Org. Chem., 2005, 70, 2161). Recent evidence showed that ferrocenecarboxylic acid was able to selectively add onto an aromatic CDI to yield an N-acylurea as the main product (see Schetter, B.; Speiser, B. J. Organomet. Chem., 2004, 689, 1472). In another report by Lau (see Rave, J.; Ankersen, M.; Begtrup, M.; Lau, J. F. Tetrahedron Lett., 2003, 44, 6931), the synthesis of di- and tri-substituted N-acylureas on a solid support was also achieved in excellent yields.

Although the thermal conversion of an N-acylurea into an isocyanate and an amide has been well documented (see Schotman, A. H. M. Recl. Trav. Chim. Pays-Bas, 1991, 110, 319, Schotman, A. H. M.; Mijs, W. J. Recl. Trav. Chim. Pays-Bas, 1992, 111, 88, and Schotman, A. H. M.; Weber, T. M. J.; Mijs, W. J. Macromol. Chem. Phys., 1999, 200, 635), the overall transformation from isocyanate to CDI and then from CDI to amide through thermolysis of the N-acylurea has not been fully exploited either as synthetic intermediates or as latent isocyanate sources. The contamination by urea and anhydride as byproducts may prevent a clean isolation of N-acylurea. Up to now, high-yield formation of an N-acylurea as an isocyanate precursor or as an isolable intermediate for polyamide synthesis has not been developed. Therefore, the present invention provides the preparation of aryl N-acylureas in both high selectivity and high yield, their consequential thermal reactions, and applications in a stepwise synthesis of aryl amides and polyamides.

### SUMMARY OF THE INVENTION

It is therefore an object of the invention to provide a process for synthesizing an aryl N-acylurea in both high selectivity and high yield, comprising reacting an aryl CDI with a carboxylic acid at a temperature below about 120° C. to obtain said aryl N-acylurea.

It is another object of the invention to provide a process for synthesizing an aryl poly-N-acylurea in both high selectivity and high yield, comprising reacting an aryl poly-CDI with a carboxylic acid, di-carboxylic acid, polycarboxylic acid or a mixture thereof at a temperature below about 120° C. to obtain said aryl poly-N-acylurea.

It is a further object of the invention to provide a process for synthesizing an amide or amide-imide through a sequential self-repetitive reaction (SSRR) at a temperature of from about 120° C. to about 280° C. in the presence of a CDI catalyst and a carboxylic acid comprising:
a) thermolyzing an aryl N-acylurea into an amide or amide-imide as a product and an aryl isocyanate as a transient product;
b) catalytically converting said aryl isocyanate into an aryl CDI in the presence of said CDI catalyst; and
c) reacting said aryl CDI and said carboxylic acid to form said aryl N-acylurea as an isolable intermediate;
wherein steps a), b) and c) are conducted self-repetitively and said carboxylic acid used in step c) is in an amount sufficient to substantially consuming all of said aryl isocyanate, said aryl CDI and said aryl N-acylurea.

It is also an object of the invention to provide a process for synthesizing an amide or amide-imide through a sequential self-repetitive reaction (SSRR) at a temperature of from about 120° C. to about 280° C. in the presence of a CDI catalyst comprising:
a) reacting an aryl CDI and a carboxylic acid to form an aryl N-acylurea as an isolable intermediate;
b) thermolyzing said aryl N-acylurea into an amide or amide-imide as a product and an aryl isocyanate; and
c) catalytically converting said aryl isocyanate into an aryl CDI in the presence of said CDI catalyst;
wherein steps a), b) and c) are conducted self-repetitively and said carboxylic acid used in step a) is in an amount sufficient to substantially consuming all of said aryl isocyanate, said aryl CDI and said aryl N-acylurea.

It is again an object of the invention to provide a process for synthesizing an amide-imide having the formula

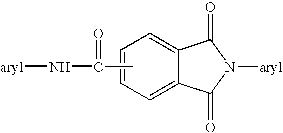

comprising:
a) reacting an aryl CDI and trimellitic anhydride to form an anhydride-functional N-acylurea having the formula

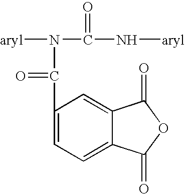

b) treating said anhydride-functional N-acylurea with water or R—OH (wherein R is C₁₋₈ alkyl) to form an acid-functionalized ester-acylurea having the formula

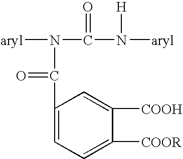

c) heating said acid-functionalized ester-acylurea in the presence of a CDI catalyst to a temperature of from about 120° C. to about 280° C. to form an aryl isocyanate and an acid-amide derivative having the formula

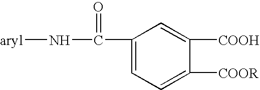

and simultaneously conducting a sequential self-repetitive reaction (SSRR) to form said amide-imide, wherein said sequential self-repetitive reaction (SSRR) involves repetitions of three sequential steps comprising:
i) catalytically converting said aryl isocyanate into an aryl CDI in the presence of said CDI catalyst;
ii) reacting said aryl CDI and said acid-amide derivative to form an acylurea having the formula

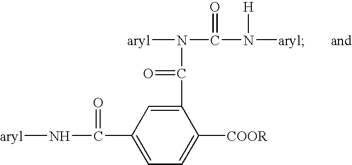

iii) thermolyzing said acylurea obtained in step ii) into said amide-imide as a product and said aryl isocyanate.

It is a final object of the invention to provide a process for synthesizing poly(amide-imide) having ordered the structural formula

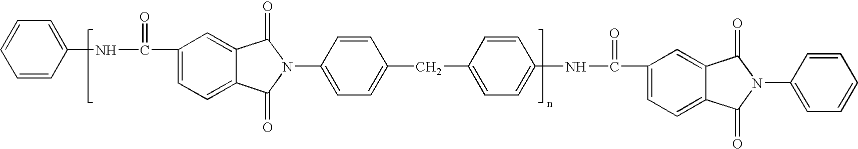

wherein n is an integer of 1 to 24, comprising:
a) reacting poly-CDI having the formula

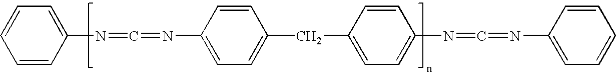

with trimellitic anhydride to form a corresponding poly-N-acylurea having the formula

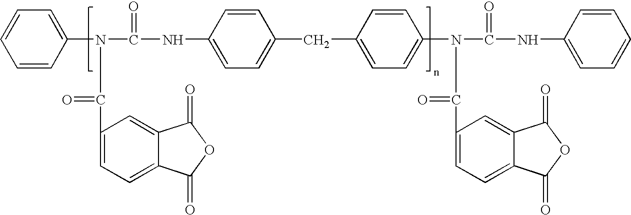

b) treating said poly-N-acylurea with water or R—OH (wherein R is C₁₋₈ alkyl) to form a poly-N-acylurea with opened anhydride functional groups:

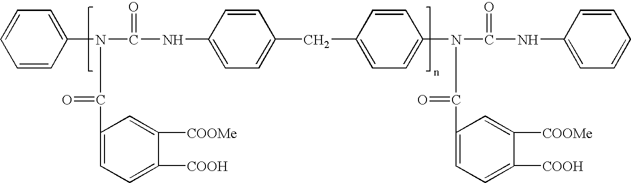

c) heating said reaction mixture to a temperature of from about 120° C. to about 280° C. to conduct the sequential self-repetitive reaction (SSRR) as defined above to form said poly(amide-imide).

Various advantages and objects of the present invention will be apparent to those skilled in the art from the descriptions below and from the appended claims.

### BRIEF DESCRIPTION OF THE DRAWINGS

FIGS. 1 to 7 show the ¹H NMR spectra of aryl N-acylureas obtained by the process of the present invention, which is illustrated in each of Examples 2 to 8.

FIGS. 8 to 10 show the ¹H NMR spectra and the DSC and TGA analyses of the obtained poly(amide-imide) obtained by the process of the present invention, which is illustrated in Example 10.

FIGS. 11 to 12 show the ¹H NMR and ¹³C NMR spectra of poly (amide-imide) obtained by one-pot process of the present invention, which is illustrated in Example 12.

### DETAILED DESCRIPTION OF THE INVENTION

At first, the present invention provides a process for synthesizing an aryl N-acylurea in both high selectivity and high yield under mild conditions.

Scheme 1 illustrates the synthesis of N-acylurea 5 from CDI 1 and carboxylic acid 2 and the possible side products, wherein two parallel reaction pathways occur. The initial formation of an O-acylisourea intermediate can either rearrange into N-acylurea 5 or undergo a further substitution reaction with another acid molecule to produce the corresponding urea 4 and anhydride 3 as final products.

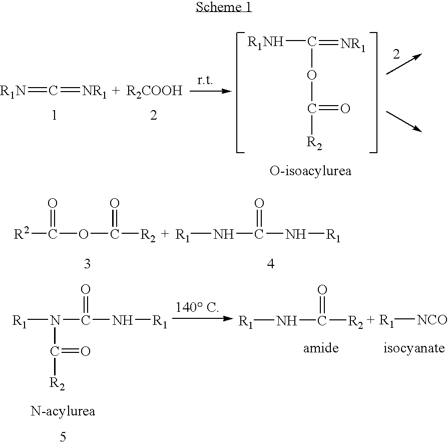

Based on the selectivity study of CDI reactions, carboxylic acids were allowed to react separately with two CDI model compounds, dicyclohexyl carbodiimide (DCC) as an aliphatic CDI, whereas diphenyl carbodiimide (DPCDI) was prepared from phenyl isocyanate and a CDI catalyst, such as 1,3-dimethyl-3-phospholene oxide (DMPO), as an aromatic CDI.

By doing so, the inventors found two distinctive product types indicating the existence of different pathways in the CDI reaction. Using DCC as a starting material to react with a carboxylic acid, such as benzoic acid and acetic acid, the reaction yielded anhydride 3 and urea 4 as the major product. A low yield of N-acylurea 5 was observed in the product mixture. Other carboxylic acids also afforded poor yields of N-acylurea 5 when being treated with DCC.

Nevertheless, the selectivity for N-acylurea 5 was enhanced dramatically when DPCDI was used instead of DCC. The migration of the acyl group from the O to N atom in the initial isourea seemed to be dominant. For example, treatment of DPCDI with a carboxylic acid, such as benzoic acid and acetic acid, at room temperature afforded a considerably high yield of N-acylurea 5, with the formation of by-products, anhydride and diphenylurea, in a minute quantity. Furthermore, the reaction between DPCDI and aromatic carboxylic acids with electron-withdrawing or electron-donating substituents generated the corresponding N-acylureas in very high selectivity.

It is also known that N-acylurea is stable below about 120° C. but decomposes at a higher temperature into fragments consisting of isocyanates and amides.

Accordingly, the present invention provides a process for synthesizing an aryl N-acylurea in both high selectivity and high yield, comprising reacting an aryl CDI with a carboxylic acid at a temperature below about 120° C. to obtain the aryl N-acylurea.

Preferably, the process of the present invention can synthesize an aryl N-acylurea in a selectivity of above 75%, more preferably above 85%, and in a yield of above 70%, more preferably above 80%. In the case of benzoic acid with DPCDI, the yield and selectivity of N-acylurea were found to be 80% and 93%, respectively. These results demonstrate that the present invention can prepare aryl N-acylureas in high yields and high selectivities under mild conditions using aryl isocyanates as starting materials.

In a more general sense, any aryl CDI can be used for carrying out the present invention. Suitable aryl CDI includes, but not limited to, diphenyl CDI, wherein either or both of the phenyl groups are optionally substituted by C₁₋₈ alkyl, C₁₋₈ alkoxy, nitro or halo. The examples of the aryl CDI are o-tolenenisocyanate, p-tolueneisocyanate, o-nitroisocyanate, p-chloroisocyanate, p-methoxyisocyanate, p-biphenylisocyanate and decahydronaphthylisocyanate.

Except for amino-acid or hydroxyl-acid, other functionalized acids could be used as carboxylic acids to prepare the respected acylureas in the present invention without much complication. There is no particular limitation to the species of the carboxylic acids used. Both aliphatic carboxylic acids and aromatic carboxylic acids optionally with electron-withdrawing or electron-donating substituents can be used for carrying out the present invention. Suitable carboxylic acid includes, but not limited to, mono-carboxylic acids, such as acetic acid and benzoic acid, di-carboxylic acids, such as adipic acid and azeleic acid, other long-chain aliphatic diacids, aromatic diacids, such as terephthalic acid and isophthalic acid, and diacids or acid anhydride such as trimellitic anhydride, poly-acids derived from anhydrides, acid anhydrides, and poly-anhydrides, and a mixture thereof.

As an example in the present invention, a trimellitic acid (or a trimellitic anhydride) with acid and anhydride in its molecular structure reacts with CDI only in the acid side leaving the anhydride side intact. This situation allows us to further manipulate the anhydride portion of the adduct for further reaction as discussed below. In this way, the present invention provides the polymerization stepwise to come up with polymers with ordered structure sequence which appears to have higher thermal stability and properties.

As well known in the art, the aryl CDI used in the present invention can be previously formed by catalytically converting aryl isocyanate in the presence of a CDI catalyst. It is preferred that this reaction is carried out in dry tetramethylene sulfone (TMS). However, other suitable solvents may be used. Suitable solvents include N,N dimethylacetamide (DMAC), N-methylpyrrolidone (NMP), N,N dimethylformamide (DMF) and dimethylsulfoxide (DMSO). Those skilled in the art are readily able to determine which solvents are suitable in carrying out this reaction.

There is no particular limitation to the species of aryl isocyanate. Suitable aryl isocyanate includes, but not limited to, aryl mono-isocyanate, aryl di-isocyanate, aryl polyisocyanate and a mixture thereof. Preferred aryl isocyanate includes phenyl isocyanate, toluene diisocyanate (TDI), methylene diphenylene diisocyanate (MDI), p-phenylene diisocyanate (PPDI), polymeric MDI, and isocyanate prepolymers made from one or more of the above. The species of the CDI catalysts are also well documented and familiar to skilled artisans. Suitable CDI catalyst includes, but not limited to, various organic derivatives of phosphorous and ringed-phophorous compounds such as 3-methyl-3-phospholene oxide (MPO), 1,3-dimethyl-3-phospholene oxide(DMPO), 1,3-dimethyl-1,3,2-diazaphophorolidine, triphenyl arsineoxide, and those listed on page 235 of Tetrahedron Report R101 in Tetrahedron Vol. 37, pages 233˜284, (1981) and Angew. Chem. Int. Ed. Vol. 1, 621 (1962), which are incorporated herewith for reference.

The present invention also provides a process for synthesizing aryl poly-N-acylurea in both high selectivity and high yield, comprising reacting an aryl poly-CDI with a carboxylic acid, di-carboxylic acid, polycarboxylic acid, or a mixture thereof at a temperature below about 120° C. to obtain said aryl poly-N-acylurea. Similar to the aryl CDIs stated above, the aryl poly-CDI can be prepared from aryl diisocyanates, aryl poly-isocyanates, or the mixtures prepared from mixing the above isocyanates by utilizing conventional technologies.

As stated above, it is known that aryl N-acylurea is thermally stable up to about 120° C. and undergoes a rapid transformation into isocyanate and amide at a higher temperature. Accordingly, the present invention further provides a new, efficient process for synthesizing an amide or amide-imide through a sequential self-repetitive reaction (SSRR) at a temperature from about 120° C. to about 280° C., preferably from about 120° C. to about 270° C., more preferably from about 140° C. to about 250° C., in the presence of a carbodiimide catalyst and carboxylic acid comprising:
a) thermolyzing an aryl N-acylurea into an amide or amide-imide as a product and an aryl isocyanate as a transient product;
b) catalytically converting said aryl isocyanate into an aryl CDI in the presence of said CDI catalyst; and
c) reacting said aryl CDI and said carboxylic acid to form said aryl N-acylurea as an isolable intermediate; wherein steps a), b) and c) are conducted self-repetitively and said carboxylic acid used in step c) is in an amount sufficient to substantially consuming all of said aryl isocyanate, said aryl CDI and said aryl N-acylurea.

As illustrated in Scheme 2, the SSRR process is consisted of three self-repetitive steps. The first step is the thermolysis of 1.0 mole of an aryl N-acylurea yielding 1.0 mole of an amide or amide-imide as a product and concurrently generating 1.0 mole of an aryl isocyanate. The second step is the catalytic conversion of 1.0 mole of the aryl isocyanate into 0.5 mole of an aryl CDI. Lastly, the third step is the reaction between the 0.5 mole of the aryl CDI and a carboxylic acid to form another 0.5 mole of the aryl N-acylurea as an isolable intermediate. Thus, it points to the fact that 50% of the aryl isocyanates were consumed in one full cycle by the sequential self-repetitive reactions (SSRR) to form 50% of the amide or amide-imide. When provided with an enough amount of carboxylic acid, repetitions of the same three sequential reactions will eventually consume all aryl N-acylureas, aryl isocyanates, and aryl CDIs. The inventors have demonstrated that highly reactive aryl isocyanate or aryl CDI compounds could be converted into soluble aryl N-acylurea intermediate in transient. The aryl N-acylureas can be isolated and converted into the high-melting amides or amide-imide directly. Compared to the known direct reaction of aryl isocyanate and carboxylic acid, the self-sequential reactions appear to offer the advantages of lower temperature conditions and higher selectivity in amide or amide-imide synthesis.

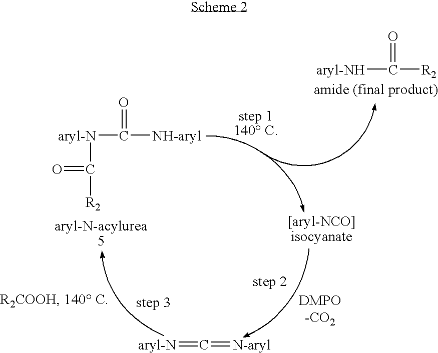

It is preferred that the aryl N-acylurea, CDI catalyst and carboxylic acid are dissolved in dry tetrahydrofuran (THF) to carry out the SSRR process. However, other suitable solvents, such as N,N dimethylacetamide (DMAC), N-methylpyrrolidone (NMP), N,N dimethylformamide (DMF) and dimethylsulfoxide (DMSO), may be used. Those skilled in the art are readily able to determine which solvents are suitable for carrying out this reaction.

In another embodiment of the present invention, the above-mentioned SSRR process can directly start from aryl CDI as a one-pot process. Thus, the present invention further provides a process for synthesizing an amide or amide-imide through a SSRR process at a temperature from about 120° C. to about 280° C., preferably from about 120° C. to about 270° C., more preferably from about 140° C. to about 250° C., in the presence of a CDI catalyst comprising:
a) reacting an aryl CDI and a carboxylic acid to form an aryl N-acylurea as an isolable intermediate;
b) thermolyzing said aryl N-acylurea into an amide or amide-imide as a product and an aryl isocyanate; and
c) catalytically converting said aryl isocyanate into an aryl CDI in the presence of said CDI catalyst;
wherein steps a), b) and c) are conducted self-repetitively and said carboxylic acid used in step a) is in an amount sufficient to substantially consuming all of said aryl isocyanate, said aryl CDI and said aryl N-acylurea.

Similarly, the aryl CDI can be formed by catalytically converting aryl isocyanate in the presence of a CDI catalyst, or the above-mentioned sequential self-repetitive reaction (SSRR) can even directly start from aryl isocyanate. Either way, all of the starting materials are preferably dissolved in a suitable solvent, such as dry tetrahydrofuran (THF), N-methylpyrrolidone (NMP), tetramethylene sulfone (TMS), N,N dimethylacetamide (DMAC), N,N dimethylformamide (DMF) and dimethylsulfoxid, to carry out the SSRR process so as to produce the desired amide or amide-imide. Those skilled in the art are readily able to determine which solvents are suitable in carrying out this reaction.

According to an embodiment of the present invention, the carboxylic acid carries an imide group at the position of R₂, and the obtained product is an amide-imide. For example, when 5-isoindolinecarboxylic acid is used as the carboxylic acid and the aryl CDI is diphenyl CDI, the obtained product is an amide-imide having the formula

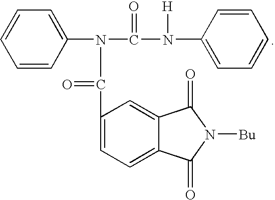

According to another embodiment of the present invention, the amide-imide can also be prepared from specific carboxylic acids with acid and anhydride in its molecular structure, such as trimellitic anhydride. In this case, the carboxylic acid used in the SSRR process to consume all aryl of aryl N-acylureas, aryl isocyanates, and aryl CDIs is trimellitic anhydride.

Accordingly, the present invention further provides a process for synthesizing an amide-imide having the formula

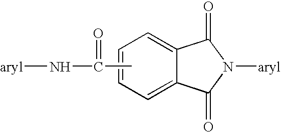

comprising:
a) reacting an aryl CDI and trimellitic anhydride to form an anhydride-functional N-acylurea having the formula

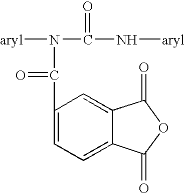

b) treating said anhydride-functional N-acylurea with water or R—OH (wherein R is C₁₋₈ alkyl) to form an acid-functionalized ester-acylurea having the formula

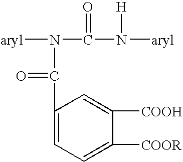

c) heating said acid-functionalized ester-acylurea in the presence of a CDI catalyst to a temperature from about 120° C. to about 280° C., preferably from about 120° C. to about 270° C., more preferably from about 140° C. to about 250° C., to form an aryl isocyanate and an acid-amide derivative having the formula

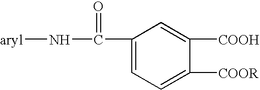

and simultaneously conducting a SSRR process to form said amide-imide, wherein said sequential self-repetitive reaction involves repetitions of three sequential steps comprising:
i) catalytically converting said aryl isocyanate into an aryl CDI in the presence of said CDI catalyst;
ii) reacting said aryl CDI and said acid-amide derivative to form an acylurea having the formula

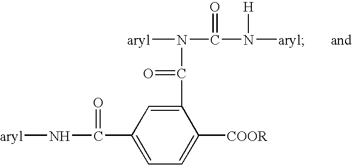

(iii) thermolyzing said acylurea obtained in step ii) into said amide-imide as a product and said aryl isocyanate.

Similarly, the aryl CDI can be formed by catalytically converting aryl isocyanate in the presence of a CDI catalyst, or the above-mentioned sequential self-repetitive reaction can even directly start from aryl isocyanate. Either way, all of the starting materials are preferably dissolved in a suitable solvent, such as dry tetrahydrofuran (THF), N-methylpyrrolidone (NMP), tetramethylene sulfone (TMS), N,N dimethylacetamide (DMAC), N,N dimethylformamide (DMF) and dimethylsulfoxide (DMSO), to carry out the SSRR process so as to produce the desired amide-imide. Those skilled in the art are readily able to determine which solvents are suitable in carrying out this reaction. Furthermore, as known in the art, the anhydride/R—OH reaction may be conducted in the presence of a catalyst such as triethylamine (TEA).

Specifically in the present invention, an N-acylurea decomposed into an amide and an isocyanate at a temperature of from about 120° C. to about 180° C. Then the reaction temperature raised to a range of about 180° C. to about 280° C. for a sufficient time, such as about 15 minutes to about 120 minutes, to affect the ring-closure and form an amide-imide.

The SSRR process according to the present invention also has been successfully applied to the synthesis of polyamide. For example, polyamide in the present invention can be prepared by reacting an aryl poly-CDI with a carboxylic acid, di-carboxylic acid, polycarboxylic acid, or a mixture thereof at a temperature below about 120° C. to obtain aryl poly-N-acylurea, and heating said aryl poly-N-acylurea to a temperature above 120° C., preferably about 140° C. to form polyamide and isocyanate. Accordingly, the present invention further provides a process for synthesizing poly(amide-imide) having ordered the structural formula

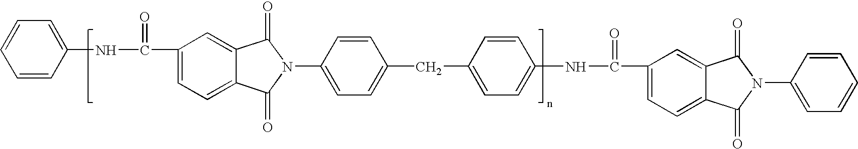

wherein n is an integer of 1 to 24,
comprising:
a) reacting poly-CDI having the formula

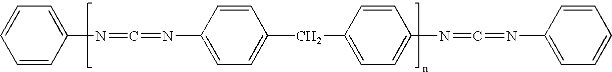

with trimellitic anhydride to form a corresponding poly-N-acylurea having the formula

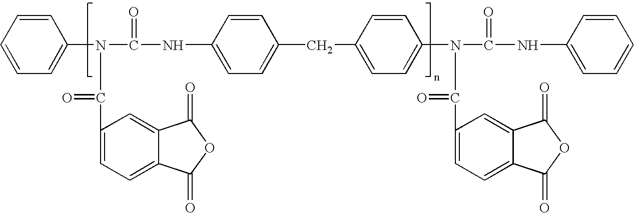

b) treating said poly-N-acylurea with water or R—OH (wherein R is C₁₋₈ alkyl) to form poly-N-acylurea with opened anhydride functional groups:

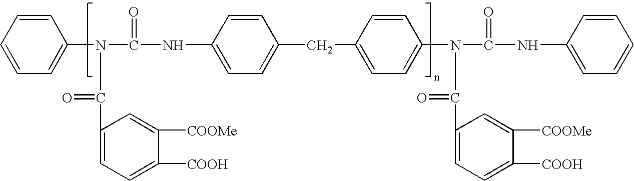

c) heating said reaction mixture to a temperature from about 120° C. to about 280° C., preferably from about 120° C. to about 270° C., more preferably from about 140° C. to about 250° C., to conduct the above-mentioned SSRR process to form said poly(amide-imide).

Preferably, n showed in the poly(amide-imide) formula is an integer of 1 to 24. When n is larger than 24, the obtained poly(amide-imide) is soluble in some solvents such as dimethylformamide (DMF) or N-methylpyrrolidone (NMP).

The SSRR process according to the present invention can also be used for synthesizing polyamide-imide (PAI) elastomers by including a long chain soft fragment, such as an ether portion, in at least a diacid component in one or more acids. In this aspect, all acid components and isocyanate components can react together in a one-pot process to obtain the resulting polyamide-imide elastomer, or one acid component first reacts with an isocyanate component, followed by adding other acid components to obtain the resulting polyamide-imide elastomer. For example, polyamide-imide-ether elastomer in the present invention can be prepared by reacting diisocyanate, polyether diacids and azelaic acids together in a one-pot process, or by first reacting diisocyanate with polyether diacids to form isocyanate-terminated prepolymers, followed by adding a CDI catalyst (e.g., DMPO) and azelaic acids. In another aspect, it can be understood that the SSRR process can also be used in the synthesis of polyurethane elastomer if the long chain soft fragment is contained in the isocyanate component.

It is well-documented in the art that poly-CDI can be prepared by reacting methylene diphenylene diisocyanate (MDI) and mono-functional phenyl isocyanate in molar ratio of 16:1 in the presence of a carbodiimide catalyst, for example, see Alberino, L. M.; Farrissey, W. J. U.S. Pat. No. 3,929,733, 1975. The entire contents of this patent are thus incorporated hereinto for reference.

Similarly, the synthesizing process is preferably carried out in a suitable solvent, such as dry tetrahydrofuran (THF), N-methylpyrrolidone (NMP), tetramethylene sulfone (TMS), N,N dimethylacetamide (DMAC), N,N dimethylformamide (DMF) and dimethylsulfoxide (DMSO), so as to produce the desired product. Those skilled in the art are readily able to determine which solvents are suitable for carrying out this reaction. Furthermore, as known in the art, the anhydride/R—OH reaction may be conducted in the presence of a catalyst such as triethylamine (TEA).

In accordance with the present invention, a process for synthesizing an aryl N-acylurea in both high selectivity and high yield, and a process for synthesizing amides, amide-imides or their polymers such as polyamides, polyamide-imides and polyamide-imide elastomers by using aryl N-acylurea as intermediates in SSRR processes can be conducted as a one-pot process. It is convenient and advantageous to be used in manufacture.

Without further elaboration, it is believed that one skilled in the art can, based on the above disclosure and the examples described below, utilize the present invention to its fullest extent. The following examples are to be construed as merely illustrative examples of how one skilled in the art can practice the claimed methods and are not limitative of the remainder of the disclosure in any way.

### EXAMPLES

General. ¹H NMR and ¹³C NMR spectra were recorded on Varian Inova 200 MHz or 600 MHz. Chemical shifts are given in δ, the coupling constants J are given in Hz. The spectra were recorded in solvents such as acetone-d6 or DMSO-d6 at room temperature, and chemical shifts are given relative to the solvent signals. FT-IR was carried out using a Perkin Elmer spectrum one FT-IR spectrometer. HPLC was performed using a 5 μm spherical particle/100 Å pore size column (Hypersil-100 C18) used an UV detection at 254 nm with MeCN/H₂O=50/50 as an eluent at a flow rate of 0.5 ml/min. Differential scanning calorimeter (DSC) was performed on a Perkin Elmer Pyris 6 instrument at heating and cooling rates of 10° C./min. Thermal gravimetric analysis (TGA) was performed using a Perkin Elmer Pyris 1 at a heating rate of 10° C./min up to 850° C. under nitrogen. The number-average molecular weight (Mn) was estimated by gel permeation chromatography (Jasco GPC, RI detector), calibrated by polystyrene standards. De-gassed N,N-dimethylformamide (DMF) was used as the eluent and performed at a flow rate of 1.0 ml min⁻¹.

### Example 1

### Preparation of Aryl N-acylurea Having the Formula

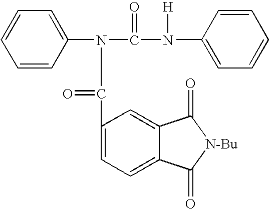

Phenyl isocyanate (5 g, 42 mmol) and, 1,3-Dimethyl-3-phospholene oxide (DMPO; 0.15 g) were dissolved in 50 ml of dry THF and was heated under nitrogen to 60° C. for 3 hours. Then 5-isoindolinecarboxylic acid 2f (5.19 g, 21 mmol) synthesized from trimellitic anhydride and butylamine was added to the reaction mixture and stirred for 3 hour at 25° C. The titled product was precipitated from 1 L of hexane (88%), and the selectivity was above 99% (as shown in Table 1). ¹H-NMR (600 MHz, acetone) [symbol] (ppm): 0.90 (t, J=7.2 Hz, 3H), 1.29 (sxt, J=7.2 Hz, 2H), 1.58-1.63 (m, 2H), 3.59 (t, J=7.2 Hz, 2H), 7.12 (dt, J=7.2, Hz, 1H), 7.25-7.37 (m, 5H), 7.45 (dd, J=8.4, 0.6 Hz, 2H), 7.60 (d, J=8.4 Hz, 2H), 7.75 (d, J=7.8 Hz, 1H), 7.91 (dd, J=6.6, 1.8 Hz, 2H), 10.80 (bs, 1H); ¹³C-NMR (150 MHz, acetone) [symbol] (ppm): 13.8, 20.6, 31.1, 38.3, 120.5, 120.6, 122.7, 123.3, 124.9, 129.1, 129.7, 129.8, 130.8, 132.7, 133.8, 134.1, 138.9, 139.5, 142.9, 152.5, 167.9, 172.4. Anal. Calcd. for C₂₆H₂₃N₃O₄: N, 9.52%; C, 70.73%; H, 5.25%. Found: N, 9.76%, C, 71.59%, H, 5.65%. mp 105.1-105.8° C.

### Examples 2 to 8

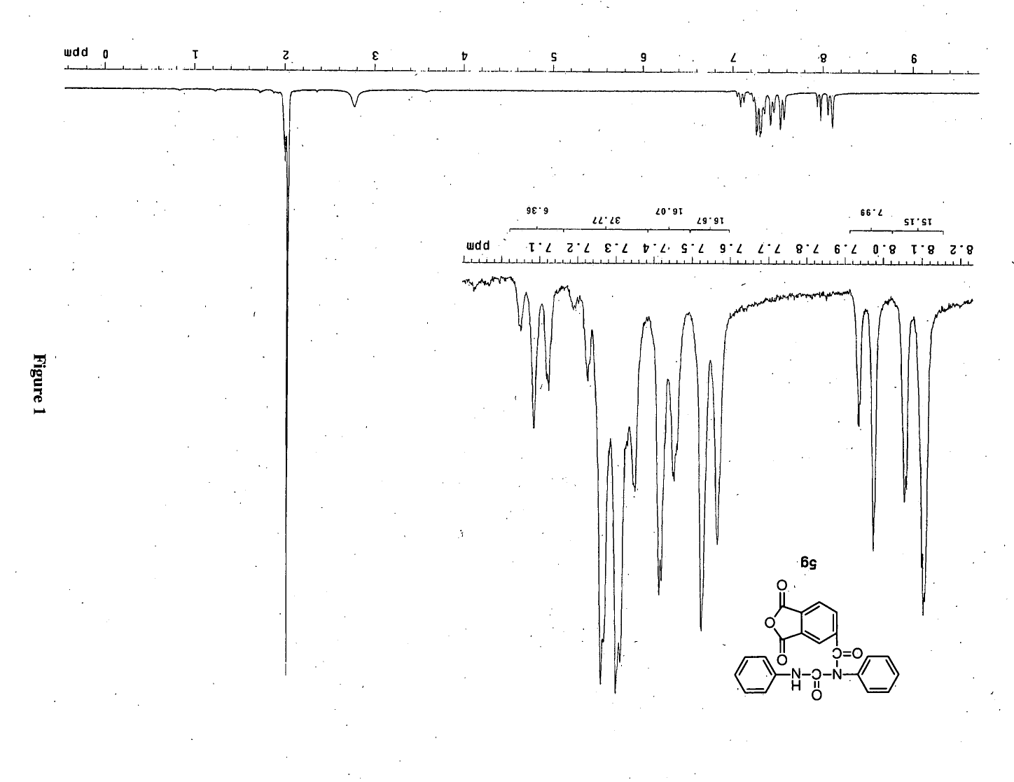

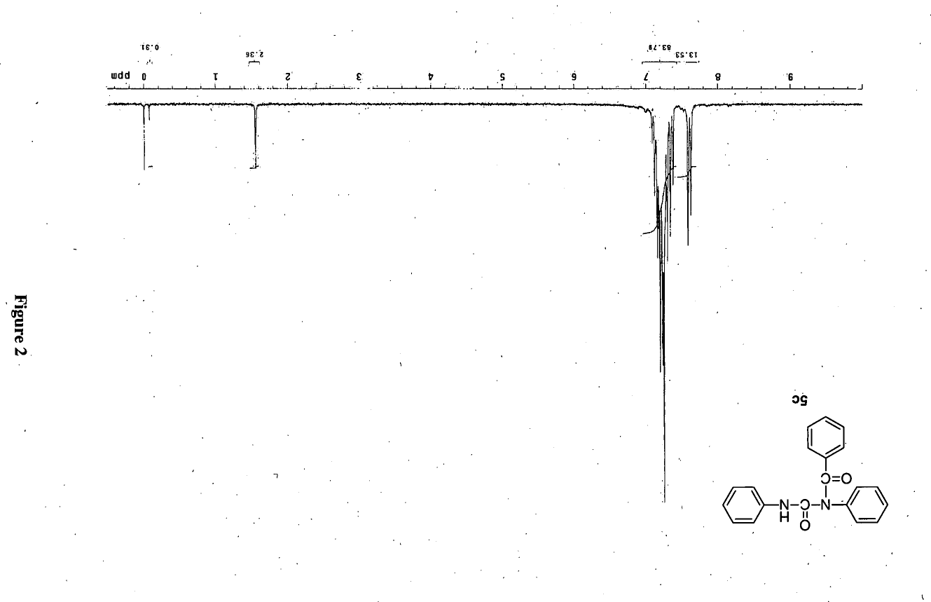

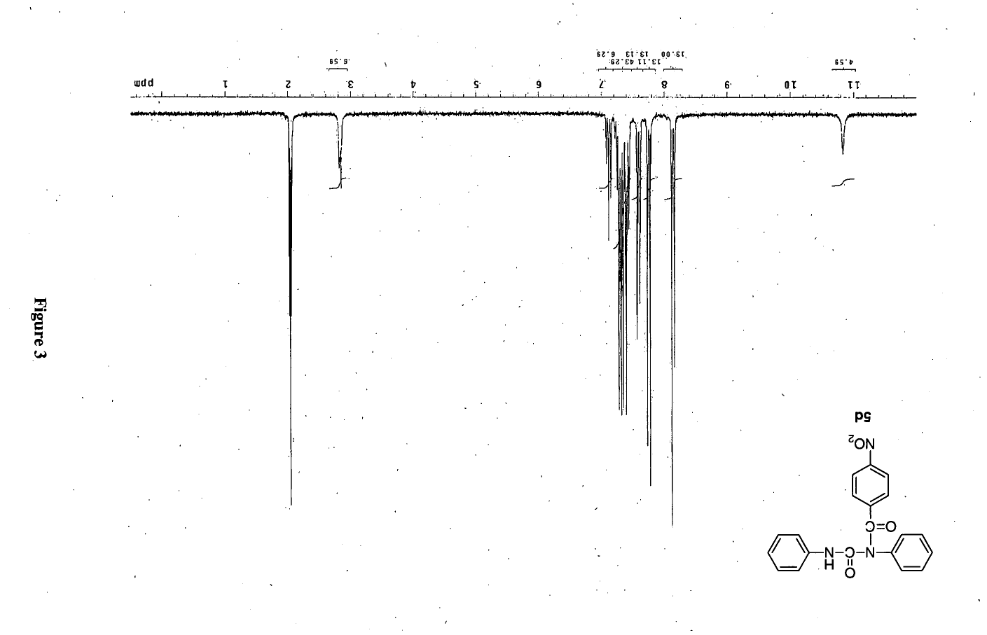

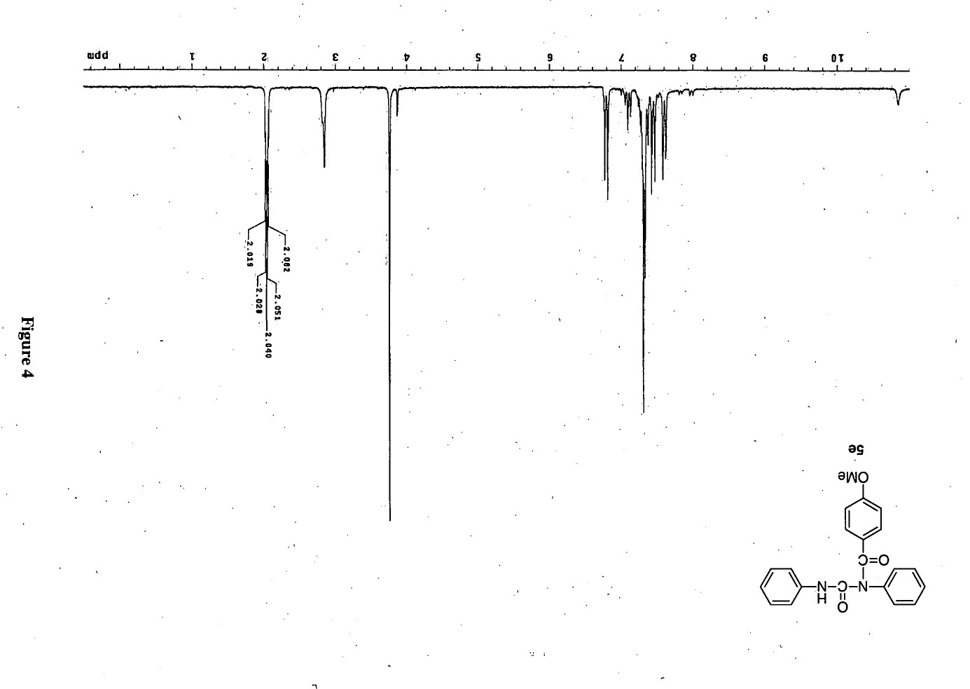

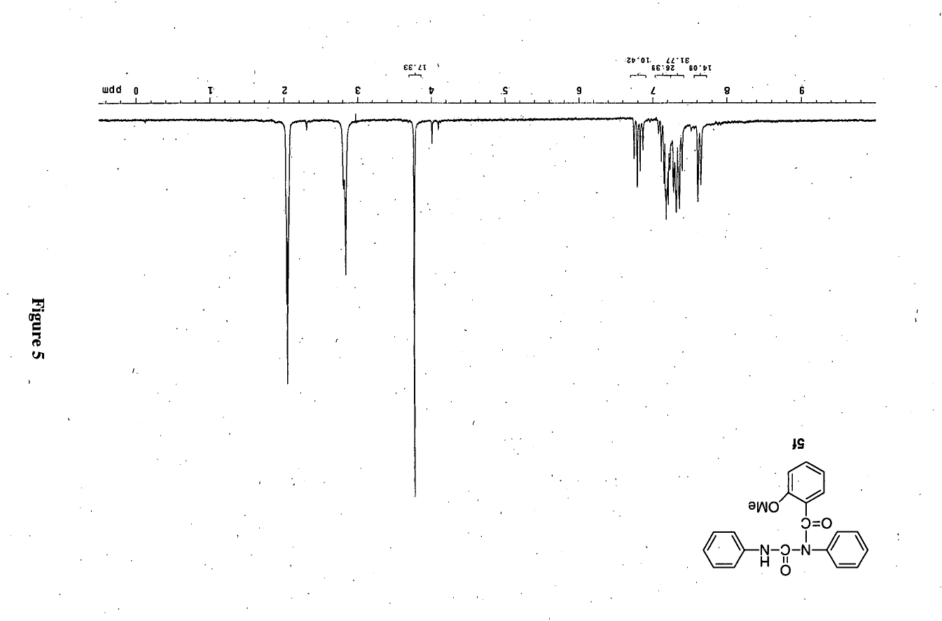

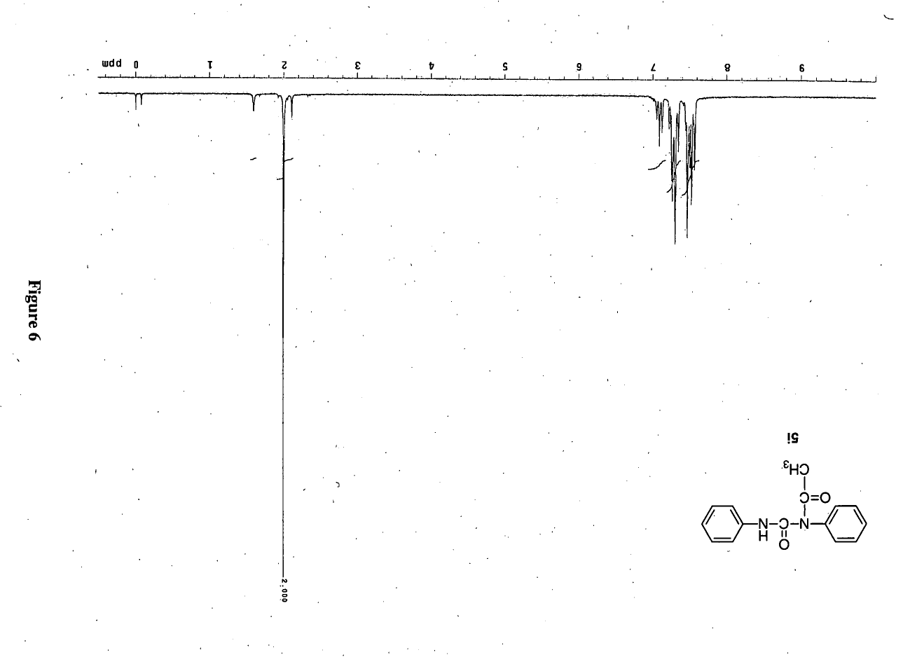

By repeating the operation procedures stated in Example 1, phenyl isocyanate and DMPO were used to react with various carboxylic acids shown in Table 1 to form corresponding aryl N-acylurea. The selectivity and yield of the obtained aryl N-acylurea were shown in Table 1. FIGS. 1 to 7 show the ¹H NMR spectra of the obtained aryl N-acylurea.

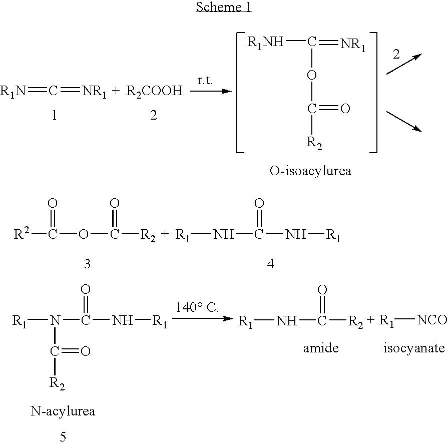

TABLE 1
Reaction of aromatic CDI and carboxylic acid (R₂COOH)

| | | | Selectivity | |
|---|---|---|---|---|
| | Aryl | | (mol %) of | |
| Example | CDI | Carboxylic acid (R₂) | N-acylurea* | Yield (%)** |
| 1 | DPCDI | 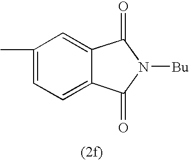 | >99 | 88 (5h) |
| 2 | DPCDI | 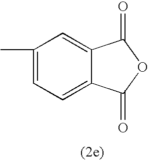 | >99 | 88 (5g) |
| 3 | DPCDI | Ph (2a) | 93 | 80 (5c) |
| 4 | DPCDI | p-NO₂-Ph (2b) | 89 | 85 (5d) |
| 5 | DPCDI | p-OMe-Ph (2c) | 98 | 88 (5e) |
| 6 | DPCDI | o-OMe-Ph (2d) | >99 | 93 (5f) |
| 7 | DPCDI | CH₃ (2g) | 95 | 90 (5i) |
| 8 | DPCDI | CH₃ (CH₂)₅ (2h) | >99 | 88 (5j) |

*Calculated by ¹H NMR integration
**Isolated by precipitation or recrystallization

### Example 9

### Preparation of Amide-Imide via the SSRR Process From the Anhydride-Functional N-acylurea

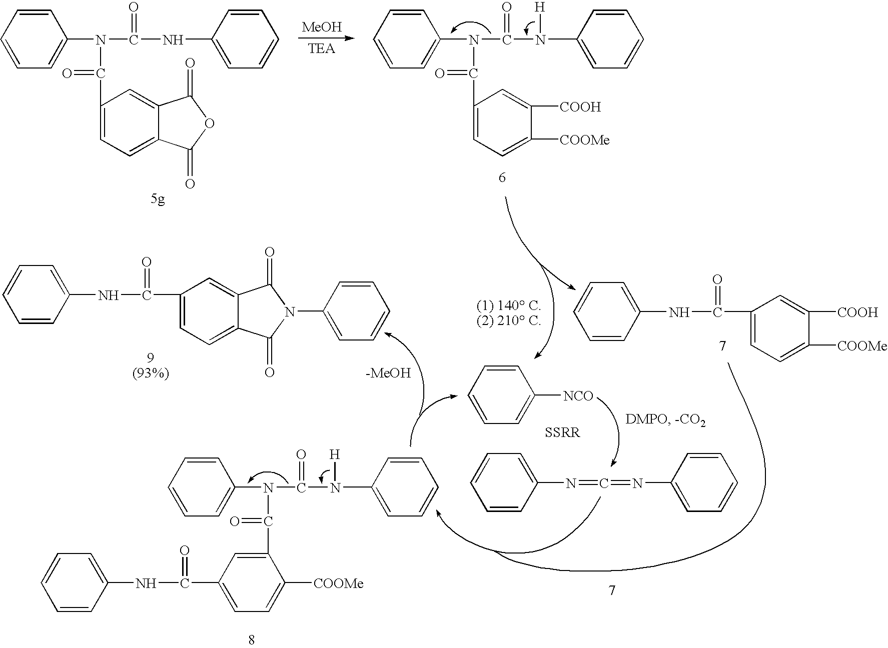

As shown in Scheme 3, anhydride-functional N-acylurea 5 g (0.5 g, 1.3 mmol) obtained from Example 2 and DMPO (75 mg, 0.57 mmol) were dissolved in 30 ml of dry tetramethylene sulfone at room temperature. Methanol (42 mg, 1.3 mmol) and triethylamine used as a catalyst (0.13 g; 1 equivalent) were added into the reaction mixture to give a new acid-functionalized ester-acylurea 6. The ester-acylurea 6 was then heated to 140° C. for 45 minutes to form the acid-amide derivative 7. The acid-amide derivative 7 was reacted with DPCDI to give a new acylurea 8 as the intermediate. The reaction temperature was finally raised to 210° C. for 30 minutes to affect the ring-closure step to yield amide-imide 9. Then, the final solution was added to 500 ml of water and a brown precipitate of amide-imide 9 formed. The precipitate was filtered and recrystallization from 25 ml of hot xylene and dried under vacuum. From this one-pot process, high yield of amide-imide 9 was isolated (93%) and confirmed by the following analyses to be the sole product. ¹H-NMR (600 MHz, DMSO) δ (ppm): 7.14 (t, J=7.2 Hz, 1H), 7.38 (t, J=7.8 Hz, 2H), 7.46-7.50 (m, 3H), 7.54 (t, J=7.8 Hz, 2H), 7.82 (d, J=7.8 Hz, 2H), 8.12 (d, J=7.8 Hz, 1H), 8.45 (dd, J=7.8, 1.8 Hz, 1H), 8.54 (s, 1H), 10.64 (s, 1H); ³C-NMR (150 MHz, DMSO) δ (ppm): 120.6, 122.2, 123.6, 124.2, 127.4, 128.2, 128.7, 128.9, 131.8, 131.9, 133.9, 134.4, 138.7, 140.3, 163.6, 166.5, 166.6. Anal. Calcd. for C₂₁H₁₄N₂O₃: N, 8.20%; C, 73.70%; H, 4.10%. Found: N, 8.21%; C, 73.59%; H, 4.42%. mp 271.4-273.1° C.

### Example 10

### Preparation of Poly(amide-imide) from poly-N-acylurea via SSRR

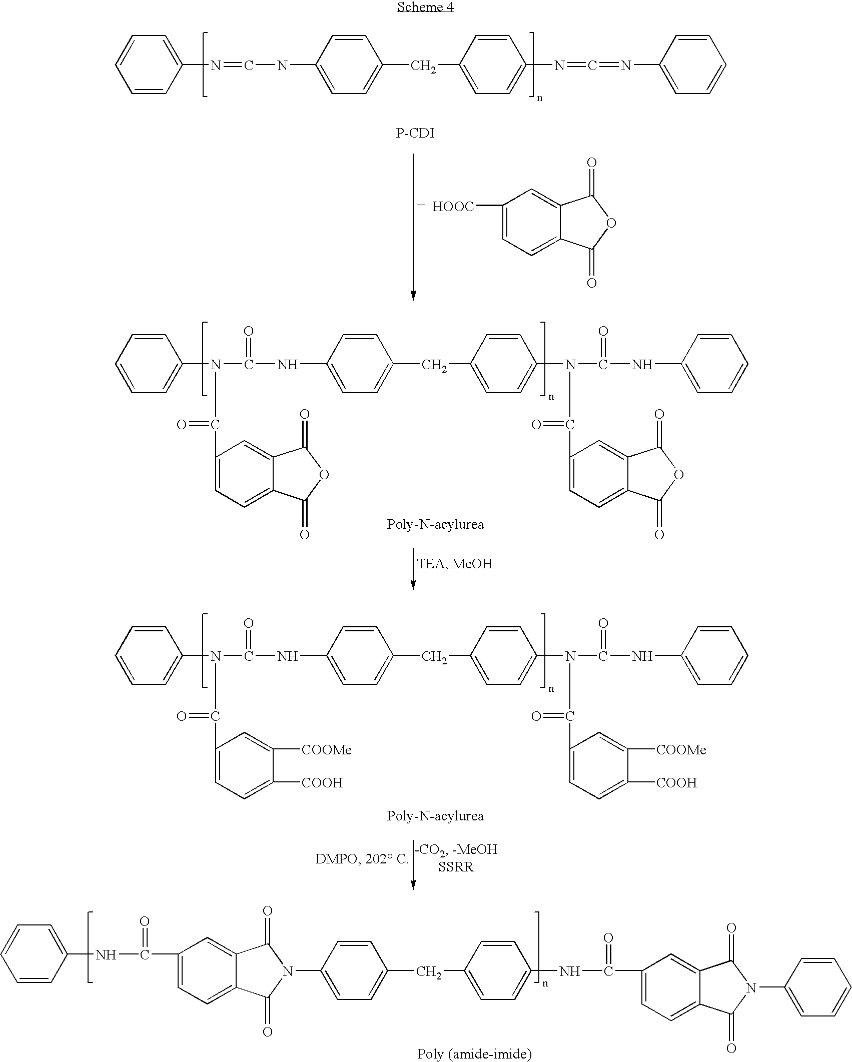

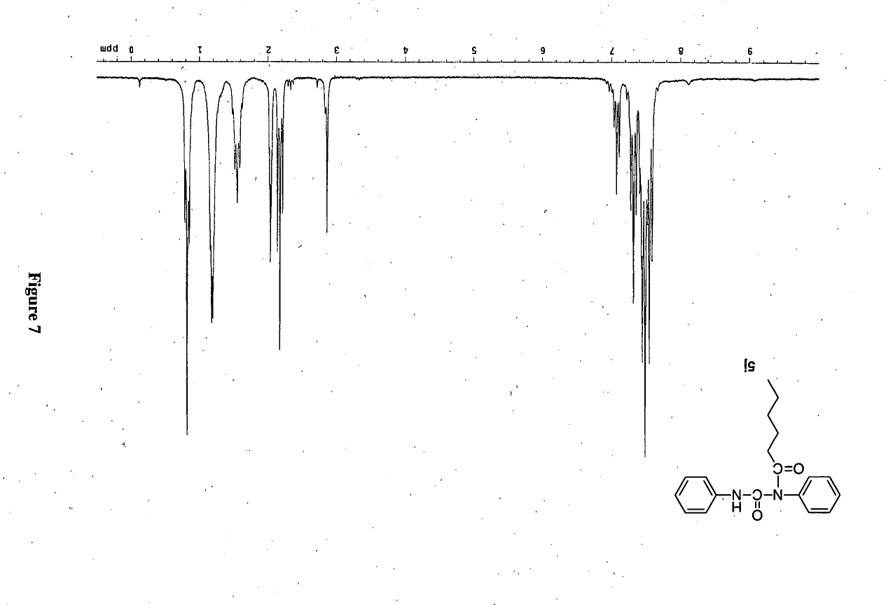

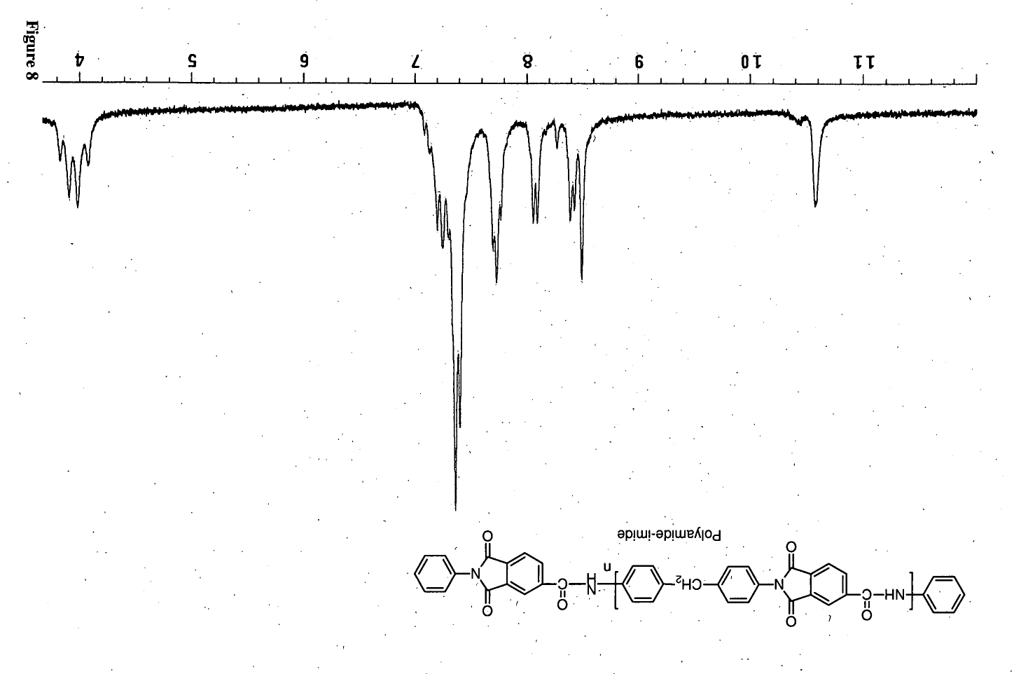

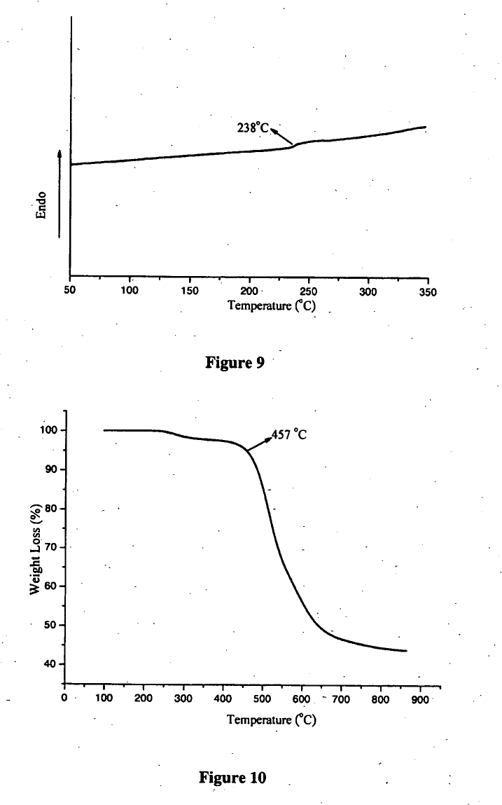

4-4′-methylene-bis(phenylisocyanate) (MDI; 15 g; 59.9 mmol) was placed into a 250-ml, three-necked, round-bottomed flask equipped with a thermometer, a nitrogen gas inlet tube, a reflux condenser, an oil bath, and a magnetic stirrer, and was dissolved in 200 ml of dry N-methyl-2-pyrrolidone (NMP). The reaction mixture was heated to 90° C. and phenyl isocyanate (0.89 g; 7.47 mmol) was added. The mixture was stirred and maintained at 90° C. for a few minutes until the solution was homogeneous and then DMPO (70 mg) was added. Evolution of carbon dioxide began almost immediately. The solution was heated at 90° C. for 3 h and the corresponding poly(carbodiimide) (P-CDI) was formed. When the mixture was cooled to room temperature, trimellitic anhydride (12.2 g; 63.5 mmol) was added and stirred for 1 h to form the corresponding poly-N-acylurea as shown in Scheme 4. Then, the mixture was added methanol (2.04 g; 63.7 mmol) and triethylamine (6.4 g; 63.7 mmol) and stirred for 30 minutes. The reaction mixture was further heated to 202° C. for 1 h and poured into 2 L of water. The resulting product was filtered and dried, to yield 23.3 g (92%) of poly(amide-imide) (brown solid) characterized by having a high T_{g} at 238° C. and T_{d} at 457° C. The number-average molecular weights (Mn) of the obtained poly(amide-imide) determined by gel permeation chromatography (GPC) was 20,600 g/mol. FIGS. 8 to 10 show the ¹H NMR spectra and the DSC and TGA analyses of the obtained poly(amide-imide).

### Example 11

### Preparation of Polyamide-imide-ether Elastomer by Using a Mixture of Two Acids

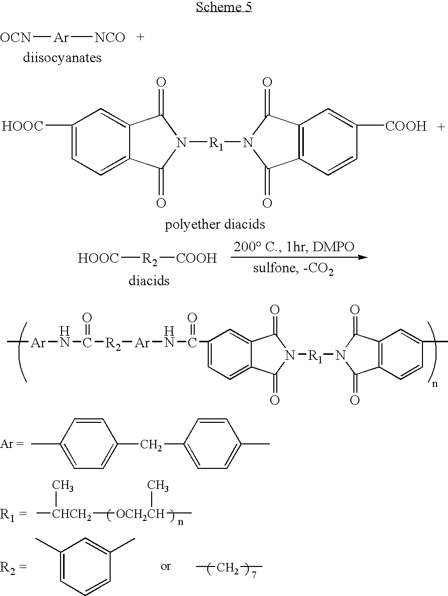

Polyether diacids (see Wei, K. L.; Hung, F. Y.; Lin, J. J. J. Polym. Sci. Part A: Polym. Chem., 2006, 44, 646) (4.53 g; 1.87 mmol) and azelaic acid (1.53 g; 8.13 mmol) were dissolved in 100 ml of TMS and placed into a 250-ml, three-necked, round-bottomed flask equipped with a thermometer, a nitrogen gas inlet tube, a reflux condenser, an oil bath, and a magnetic stirrer. The solution was heated to 180° C., then DMPO (0.25 g) and MDI (3.0 g; 12 mmol) were added and stirred for 30 minutes. The solution was then heated to 200° C. and stirred for 2 hours. The resulting solution was poured into 1.5 L of water. The product, after being filtered and dried in a vacuum oven to remove water, was polyamide-imide-ether elastomer which was characterized by having a high T_{g} at −33° C. (polyether) and T_{d} at 378° C.

### Example 12

### One-Pot Synthesis of PAI

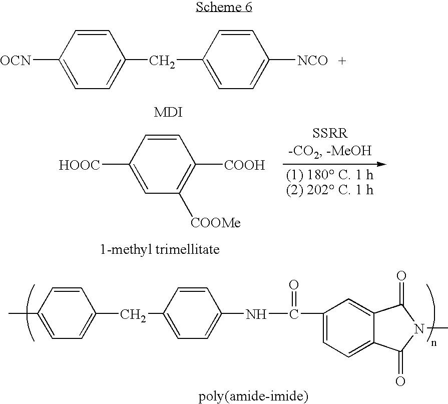

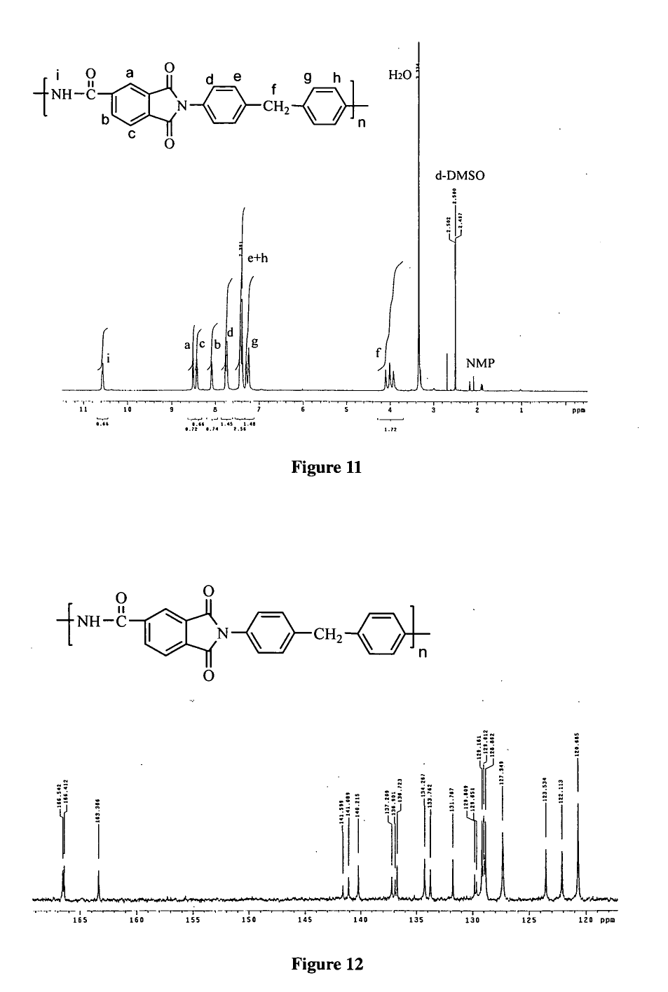

NMP (15 ml) was placed into a 250-ml, three-necked, round-bottomed flask equipped with a thermometer, a nitrogen gas inlet tube, a reflux condenser, an oil bath, and a magnetic stirrer. NMP was heated to 180° C., follow by adding DMPO 40 mg and 1-methyl trimellitate (1 g; 4.47 mmol). MDI (1.12 g; 4.47 mmol) was added to the mixture and follow by heating to 200° C. and stirred for 2 hours. The resulting solution was poured into 500 ml of water and a brown precipitate of PAI formed. The precipitate was filtered and dried under vacuum. From this one-pot process, high yield of PAI was isolated (90%). ¹H NMR and ¹³C NMR were shown in FIG. 11 and FIG. 12 respectively. PAI was characterized by having a high T_{g} at 289° C. and T_{d} at 479° C.

### Comparative Examples 1 and 2

Dicyclohexyl carbodiimide (DCC) was used as a starting material to react with benzoic acid (Comparative Example 1) or acetic acid (Comparative Example 2) under the operation conditions similar to those illustrated in Example 1. As shown in Table 2, the reaction yielded anhydride and urea as the major product. Low selectivity (38% and 25% of Comparative Examples 1 and 2, respectively) of N-acylurea was observed in the product mixture.

TABLE 2
Reaction of aliphatic CDI and carboxylic acid (R₂COOH)

| | Aliphatic | Carboxylic acid | Selectivity (mol %) | Yield |
|---|---|---|---|---|
| Example | CDI | (R₂) | of N-acylurea* | (%)** |
| 1 | DCC | Ph | 38 | n.d.*** |
| 2 | DCC | CH₃ | 25 | n.d. |

*Calculated by ¹H NMR integration
**Isolated by precipitation or recrystallization
***n.d. = Not determined due to complicated product mixtures (anhydride + urea + N-acylurea)

It will be readily apparent that various modifications of the invention are possible and will readily suggest themselves to those skilled in the art and are contemplated.

What is claimed is:

1. A process for synthesizing an aryl N-acylurea in both high selectivity and high yield, comprising reacting an aryl carbodiimide (CDI) with a carboxylic acid at a temperature below about 120° C. to obtain said aryl N-acylurea.

2. The process according to claim 1, wherein said aryl CDI is formed by catalytically converting an aryl mono-isocyanate, aryl di-isocyanate, aryl polyisocyanate or a mixture thereof in the presence of a CDI catalyst.

3. The process according to claim 1, wherein said aryl CDI is formed by catalytically converting phenyl isocyanate, toluene diisocyanate (TDI), methylene diphenylene diisocyanate (MDI), p-phenylene diisocyanate (PPDI), polymeric MDI, or isocyanate prepolymers made from one or more of the above in the presence of a CDI catalyst.

4. The process according to claim 1, wherein said aryl CDI is selected from the group consisting of diphenyl CDI, wherein either or both of the phenyl groups are optionally substituted by C₁₋₈ alkyl, C₁₋₈ alkoxy, nitro or halo.

5. The process according to claim 1, wherein said carboxylic acid is selected from the group consisting of mono-carboxylic acids, di-carboxylic acids, other long-chain aliphatic diacids, aromatic diacids, and diacids or acid anhydrides, and a mixture thereof.

6. The process according to claim 5, wherein said carboxylic acid is selected from the group consisting of acetic acid, benzoic acid, adipic acid, azeleic acid, terephthalic acid, isophthalic acid, trimellitic anhydride, poly-acids derived from anhydrides, acid anhydrides, and poly-anhydrides and a mixture thereof.

7. The process according to claim 1, wherein said selectivity is above 75% and said yield is above 70%.

8. The process according to claim 7, wherein said selectivity is above 85% and said yield is above 80%.

9. A process for synthesizing an aryl poly-N-acylurea in both high selectivity and high yield, comprising reacting an aryl poly-CDI with a carboxylic acid, di-carboxylic acid, polycarboxylic acid, or a mixture thereof at a temperature below about 120° C. to obtain said aryl poly-N-acylurea.

10. The process according to claim 9, wherein said aryl poly-CDI is prepared from aryl diisocyanates, aryl poly-isocyanates, or the mixtures prepared from the mixing of the above isocyanates.

11. A process for synthesizing an amide or amide-imide through a sequential self-repetitive reaction at a temperature of from about 120° C. to about 280° C. in the presence of a CDI catalyst and a carboxylic acid comprising:
a) thermolyzing an aryl N-acylurea into an amide or amide-imide as a product and an aryl isocyanate;
b) catalytically converting said aryl isocyanate into an aryl CDI in the presence of said CDI catalyst; and
c) reacting said aryl CDI and said carboxylic acid to form said aryl N-acylurea as an isolable intermediate;
wherein steps a), b) and c) are conducted self-repetitively and said carboxylic acid used in step c) is in an amount sufficient to substantially consuming all of said aryl isocyanate, said aryl CDI and said aryl N-acylurea.

12. The process according to claim 11, wherein said aryl N-acylurea is obtained from the process according to claim 1.

13. The process according to claim 11, wherein said carboxylic acid is selected from the group consisting of mono-carboxylic acids, di-carboxylic acids, other long-chain aliphatic diacids, aromatic diacids, and diacids or acid anhydride, and a mixture thereof.

14. The process according to claim 13, wherein said carboxylic acid is selected from the group consisting of acetic acid, benzoic acid, adipic acid, azeleic acid, terephthalic acid, isophthalic acid, trimellitic anhydride, poly-acids derived from anhydrides, acid anhydrides, and poly-anhydrides and a mixture thereof.

15. The process according to claim 11, wherein said temperature is from about 120° C. to about 270° C.

16. The process according to claim 15, wherein said temperature is from about 140° C. to about 250° C.

17. The process according to claim 11, wherein said carboxylic acid carries an imide group, and said product is an amide-imide.

18. The process according to claim 17, wherein said carboxylic acid is 5-isoindolinecarboxylic acid, and said product is an amide-imide having the formula

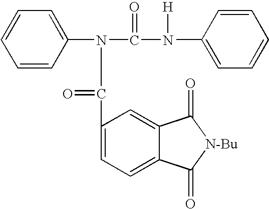

19. A process for synthesizing an amide or amide-imide through a sequential self-repetitive reaction at a temperature from about 120° C. to about 280° C. in the presence of a CDI catalyst comprising:
a) reacting an arlyl CDI and a carboxylic acid to form an aryl N-acylurea as an isolable intermediate;
b) thermolyzing said aryl N-acylurea into an amide or amide-imide as a product and an aryl isocyanate; and
c) catalytically converting said aryl isocyanate into an aryl CDI in the presence of said CDI catalyst;
wherein steps a), b) and c) are conducted self-repetitively and said carboxylic acid used in step a) is in an amount sufficient to substantially consuming all of said aryl isocyanaie, said aryl CDI and said aryl N-acylurea.

20. The process according to claim 19 wherein said aryl CDI is formed by catalytically converting an aryl mono-isocyanate, aryl di-isocyanate, aryl polyisocyanate or a mixture thereof in the presence of a CDI catalyst.

21. The process according to claim 19, wherein said aryl CDI is formed by catalytically converting phenyl isocyanate, toluene diisocyanate (TDI), methylene diphenylene diisocyanate (MDI), p-phenylene diisocyanate (PPDI), polymeric MDI, or isocyanate prepolymers made from one or more of the above in the presence of a CDI catalyst.

22. The process according to claim 1₉ wherein said aryl CDI is selected from the group consisting of diphenyl CDI, wherein either or both of the phenyl groups are optionally substituted by C₁₋₈ alkyl, C₁₋₈ alkoxy, nitro or halo.

23. The process according to claim 19, wherein said carboxylic acid is selected from the group consisting of mono-carboxylic acids, di-carboxylic acids, other long-chain aliphatic diacids, aromatic diacids, and diacids or acid anhydride, and a mixture thereof.

24. The process according to claim 23, wherein said carboxylic acid is selected from the group consisting of acetic acid, benzoic acid, adipic acid, azeleic acid, terephthalic acid, isophthalic acid, trimellitic anhydride, poly-acids derived from anhydrides, acid anhydrides, and poly-anhydrides and a mixture thereof.

25. The process according to claim 19, wherein said temperature is from about 120° C. to about 270° C.

26. The process according to claim 25, wherein said temperature is from about 140° C. to about 250° C.

27. The process according to claim 19, wherein said carboxylic acid carries an imide group, and said product is an amide-imide.

28. The process according to claim 27, wherein said carboxylic acid is 5-isoindolinecarboxylic acid, and said product is an amide-imide having the formula

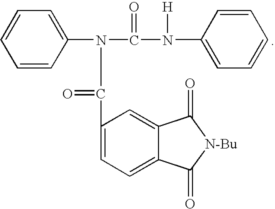

29. A process for synthesizing an amide-imide having the formula 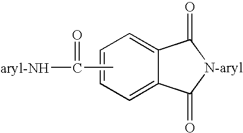
comprising:
a) reacting an aryl CDI and trimellitic anhydride to form an anhydride-functional N-acylurea having the formula 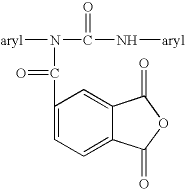
b) treating said anhydride-functional N-acylurea with water or R—OH (wherein R is C₁₋₈ alkyl to form a acid-functionalized ester-acylurea having the formula 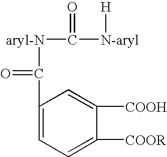
c) heating said acid-functionalized ester-acylurea in the presence of a CDI catalyst to a temperature from about 120° C. to about 280° C. to form an aryl isocyanate and an acid-amide derivative having the formula 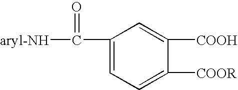
and simultaneously conducting a sequential self-repetitive reaction to form said amide-imide, wherein said sequential self-repetitive reaction involves repetitions of three sequential steps comprising:
i) catalytically converting said aryl isocyanate into an aryl CDI in the presence of said CDI catalyst;
ii) reacting said aryl CDI and said acid-amide derivative to form an acylurea having the formula 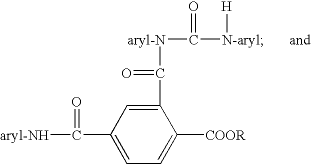
iii) thermolyzing said acylurea obtained in step ii) into said amide-imide as a product and said aryl isocyanate.

30. The process according to claim 29, wherein said aryl CDI is formed by catalytically converting an aryl mono-isocyanate, aryl di-isocyanate, aryl polyisocyanate or a mixture thereof in the presence of a CDI catalyst.

31. The process according to claim 30, wherein said aryl CDI is formed by catalytically converting phenyl isocyanate, toluene diisocyanate (TDI), methylene diphenylene diisocyanate (MDI), p-phenylene diisocyanate (PPDI), polymeric MDI, or isocyanate prepolymers made from one or more of the above in the presence of a CDI catalyst.

32. The process according to claim 29, wherein said temperature in step c) is from about 120° C. to about 270° C.

33. The process according to claim 32, wherein said temperature in step c) is from about 140° C. to about 250° C.

34. A process for synthesizing a poly(amide-imide) having ordered the structural formula 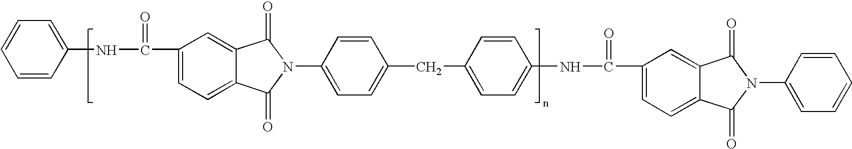
wherein n is an integer between 1 to 24, comprising:
a) reacting a poly-CDI having the formula 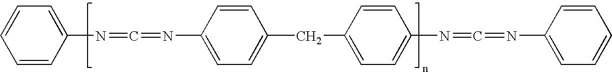
with trimellitic anhydride to form corresponding poly-N-acylurea having the formula 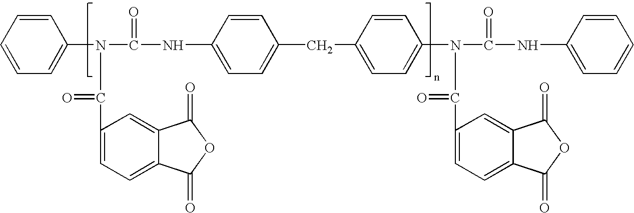
b) treating said poly-N-acylurea with water or R—OH (wherein R is C1-8 alkyl) to form a poly-N-acylurea with opened anhydride functional groups: 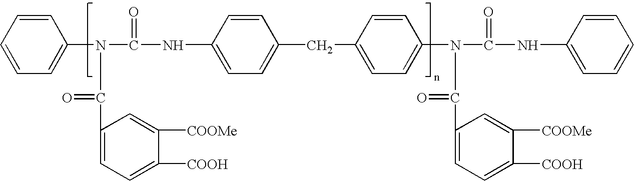
c) heating said reaction mixture to a temperature from about 120° C. to about 280° C. to conduct said sequential self-repetitive reaction as defined in claim 29 to form said poly(amide-imide).

35. The process according to claim 34, said poly-CDI is formed by reacting methylene diphenylene diisocyanate and phenyl isocyanate in the presence of a CDI catalyst.

36. The process according to claim 34, wherein said temperature in step c) is from about 120° C. to about 270° C.

37. The process according to claim 37, wherein said temperature in step c) is from about 140° C. to about 250° C.

38. The process according to claim 34 being a one-pot process.

39. A process for synthesizing a polyamide, comprising heating said aryl poly-N-acylurea obtained from the process according to claim 9 to a temperature above about 120° C. to form said polyamide and an isocyanate.

40. The process of claim 38, wherein said temperature is about 140° C.

41. A process for synthesizing a poly(amide-imide) comprising:
a) reacting a poly-CDI with an anhydride to form corresponding poly-N-acylurea;
b) treating said poly-N-acylurea with water or R—OH (wherein R is C₁₋₈ alkyl) to form a poly-N-acylurea with opened anhydride functional groups;
c) heating said reaction mixture to a temperature from about 120° C. to about 280° C. to conduct said sequential self-repetitive reaction as defined in claim 29 to form said poly(amide-imide).

42. The process of claim 41, wherein said anhydride in step a) is a mixture of one or more acids or anhydrides.

43. The process of claim 42, wherein said acid in step a) includes a long chain soft fragment, and said product is a polyamide-imide elastomer.

44. The process of claim 43, wherein said acid in step a) is an diacid including an ether portion, and said product is a polyamide-imide-ether elastomer.
